(19) United States
(12) Patent Application Publication
(10) Pub. No.: US 2026/0011736 A1
(43) Pub. Date: Jan. 8, 2026

(54) ELECTRODE AND METHOD OF MANUFACTURING SAME

(71) Applicant: Samsung SDI Co., Ltd., Yongin-si (KR)

(72) Inventor: Taewoong Jang, Yongin-si (KR)

(73) Assignee: Samsung SDI Co., Ltd., Yongin-si (KR)

(21) Appl. No.: 18/960,746

(22) Filed: Nov. 26, 2024

(30) Foreign Application Priority Data
Jul. 3, 2024 (KR) 10-2024-0087653

(51) Int. Cl. H01M 4/62; H01M 4/04; H01M 50/531

(52) U.S. Cl. CPC H01M 4/622; H01M 4/0404; H01M 50/531

(57) ABSTRACT

An electrode is provided. The electrode includes: a substrate extending in a first direction, wherein the substrate includes a mixture portion, on which an active material is applied to at least one surface of the substrate and a non-coating portion disposed on an end of the substrate and at which the substrate is exposed; a substrate tab connected to the non-coating portion and protruding in a second direction that intersects the first direction; and a conductive adhesion layer disposed between the non-coating portion and the substrate tab.

### CROSS-REFERENCE TO RELATED APPLICATIONS

This present application claims priority to and the benefit under 35 U.S.C. §119(a)-(d) of Korean Patent Application No. 10-2024-0087653, filed on Jul. 3, 2024, in the Korean Intellectual Property Office, the entire disclosure of which is incorporated herein by reference.

### FIELD

The present disclosure relates to an electrode and a method of manufacturing the same.

### BACKGROUND

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

The present disclosure has been proposed to improve the above-described problems, and an objective of the present disclosure is to provide an electrode and a method of manufacturing the same.

These and other aspects and features of the present disclosure will be described in or will be apparent from the following description of embodiments of the present disclosure.

An electrode according to some embodiments of the present disclosure includes: a substrate extending in a first direction, wherein the substrate comprises a mixture portion, on which an active material is applied to at least one surface of the substrate, and a non-coating portion disposed on an end of the substrate at which the substrate is exposed; a substrate tab connected to the non-coating portion and protruding in a second direction that intersects the first direction; and a conductive adhesion layer disposed between the non-coating portion and the substrate tab.

In some embodiments of the present disclosure, a width of the adhesion layer may be equal to a width of the substrate tab with respect to the first direction.

In some embodiments of the present disclosure, a width of the adhesion layer may be greater than a width of the substrate tab with respect to the first direction, and the adhesion layer may protrude by a first length to at least one side of the substrate tab with respect to the first direction.

In some embodiments of the present disclosure, the first length by which the adhesion layer protrudes from the substrate tab may be within about ⅓ of the width of the substrate tab.

In some embodiments of the present disclosure, the first length by which the adhesion layer protrudes from the substrate tab may be within about 1 mm.

In some embodiments of the present disclosure, a width of the adhesion layer may be equal to a width of the substrate with respect to the second direction.

In some embodiments of the present disclosure, a width of the adhesion layer may be greater than a width of the substrate with respect to the second direction, and the adhesion layer may protrude further than the substrate by a second length in a direction in which the substrate tab protrudes.

In some embodiments of the present disclosure, in the adhesion layer, a conductive adhesive may be applied to the non-coating portion of the substrate or the substrate tab.

In some embodiments of the present disclosure, in the adhesion layer, a conductive tape may be attached to the non-coating portion of the substrate or the substrate tab.

In some embodiments of the present disclosure, the adhesion layer may include at least one of isotropic conductive adhesives (ICAs) or anisotropic conductive adhesives (ACAs).

In some embodiments of the present disclosure, the adhesion layer may have a thickness of about 20 μm to about 50 μm.

A method of manufacturing an electrode according to some embodiments of the present disclosure includes providing a substrate extending in a first direction, the substrate comprising a mixture portion, on which an active material is applied to at least one surface of the substrate, and a non-coating portion disposed on an end of the substrate at which the substrate is exposed, providing a substrate tab, disposing a conductive adhesion layer on one area of the non-coating portion or the substrate tab, and bonding the non-coating portion and the substrate tab to each other through the adhesion layer so that the substrate tab protrudes with respect to the non-coating portion in a second direction that intersects the first direction.

In some embodiments of the present disclosure, a width of the adhesion layer may be equal to a width of the substrate tab with respect to the first direction.

In some embodiments of the present disclosure, a width of the adhesion layer may be greater than a width of the substrate tab with respect to the first direction, and the adhesion layer may protrude by a first length to at least one side of the substrate tab with respect to the first direction.

In some embodiments of the present disclosure, the first length by which the adhesion layer protrudes from the substrate tab may be within about ⅓ of the width of the substrate tab.

In some embodiments of the present disclosure, the first length by which the adhesion layer protrudes from the substrate tab may be within about 1 mm.

In some embodiments of the present disclosure, a width of the adhesion layer may be equal to a width of the substrate with respect to the second direction.

In some embodiments of the present disclosure, the adhesion layer may protrude further than the substrate by a second length in a direction in which the substrate tab protrudes.

In some embodiments of the present disclosure, the adhesion layer may include at least one of isotropic conductive adhesives (ICAs) or anisotropic conductive adhesives (ACAs).

In some embodiments of the present disclosure, the method may further include, after bonding the non-coating portion and the substrate tab to each other, pressing the substrate tab.

According to some embodiments of the present disclosure, the adhesion layer may be entirely disposed on the area on which a substrate and a substrate tab overlap each other to maximize the area on which the substrate and the substrate tab are connected to each other. Therefore, the stress concentrated at the connection portion between the substrate and the substrate tab due to the elongation may be maximally dispersed to prevent the cracks from occurring or prevent the substrate tab from being separated from the substrate.

According to some embodiments of the present disclosure, the stress concentrated at the corner at which the substrate and the substrate tab cross each other may be dispersed to the adhesion layer. The stress concentrated at the corner at which the substrate and the substrate tab intersect each other may be dispersed to the adhesion layer through the elongation of the binder layer of the adhesion layer to prevent the cracks from occurring in the substrate or prevent the substrate tab from being separated from the substrate.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a longitudinal cross-sectional view of an example of a battery according to an embodiment of the present disclosure.

FIG. 2 illustrates an enlarged side view of an example of electrodes according to an embodiment of the present disclosure.

FIG. 3 illustrates a cross-sectional view of an example of an adhesion layer according to an embodiment of the present disclosure.

FIG. 4 illustrates a one-way side view of an example of an adhesion layer of an electrode according to a first embodiment of the present disclosure.

FIG. 5 illustrates a cross-sectional view of an example of an adhesion layer of an electrode according to the first embodiment of the present disclosure.

FIG. 6 illustrates a one-way side view of an example of an adhesion layer of an electrode according to a second embodiment of the present disclosure.

FIG. 7 illustrates a cross-sectional view of an example of an adhesion layer of an electrode according to the second embodiment of the present disclosure.

FIG. 8 illustrates a one-way side view of an example of an adhesion layer of an electrode according to a third embodiment of the present disclosure.

FIG. 9 illustrates a cross-sectional view of an example of an adhesion layer of an electrode according to the third embodiment of the present disclosure.

FIG. 10 illustrates a view of an example of a coating method using an adhesive according to an embodiment of the present disclosure.

FIG. 11 illustrates a view of a comparative example of an electrode.

FIG. 12 illustrates a flowchart for explaining a method of manufacturing a battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, dimensions of areas and relative sizes shown in the drawings may be exaggerated for clarity of description. That is, the dimension shown in the drawings are only for convenience of understanding and are not limited thereto. Throughout the present disclosure, like reference numerals refer to like elements throughout this disclosure.

An electrode assembly may be provided by stacking electrodes including a positive electrode and a negative electrode and a separator or winding the electrodes and the separator, which are in the stacked state. A substrate tab connected to the electrode may be connected to an electrode terminal to serve as an electrical path between the electrode assembly and the electrode terminal.

The electrode and the substrate tab may be connected by ultrasonic welding or laser welding. In this case, there is a limitation that short circuit of the battery occurs due to foreign substances generated during the welding. In addition, in the case of a coin cell or a button cell, there is a limitation that a width of the substrate is provided to be narrower than that of each of other cells, making it difficult to secure a welding space.

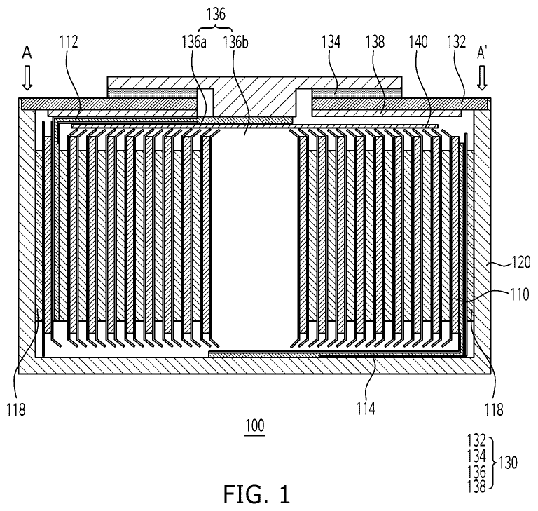

FIG. 1 illustrates a longitudinal cross-sectional view of an example of a battery 100 according to an embodiment of the present disclosure. The battery 100 may include an electrode assembly 110, a case 120, a cap assembly 130, and an insulating washer 140.

The battery 100 may be a coin-type or button-type battery. For example, the battery 100 may have a cylindrical shape. However, the battery 100 is not limited thereto and may be a prismatic type, pouch type, cylindrical type battery, etc. In some embodiments, the battery 100 may be a secondary battery that is chargeable and dischargeable.

The electrode assembly 110 may include a first electrode, a second electrode, and a separator. In some embodiments, the electrode assembly 110 may be provided by winding the separator interposed between the first electrode and the second electrode. The electrode assembly 110 may be wound to provide a core and may include a through-hole in the core.

The first electrode may include a first substrate and a first substrate tab 112 connected to the first substrate. The first substrate may include a first mixture portion, on which a first active material is applied to at least a surface thereof, and a first non-coating portion disposed at an end of the first substrate to expose the first substrate. The first substrate tab 112 may extend outward from the first non-coating portion, on which the active material layer is not applied, on the first substrate, and the first substrate tab 112 may be electrically connected to a terminal plate 136 of the cap assembly 130.

The second electrode may include a second substrate and a second substrate tab 114 connected to the second substrate. The second substrate may include a second mixture portion, on which a second active material is applied to at least a surface thereof, and a second non-coating portion disposed at an end of the second substrate to expose the second substrate. The second substrate tab 114 may extend outward from a second non-coating portion, on which the active material layer is not applied, on the second substrate, and the second substrate tab 114 may be electrically connected to the case 120.

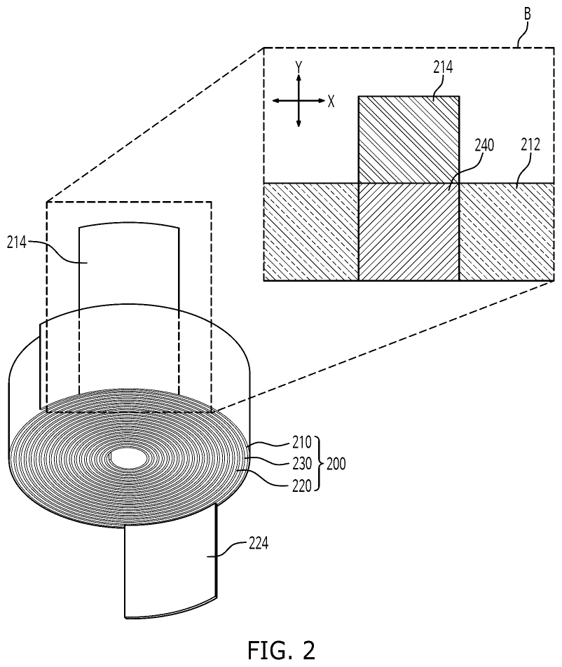

In some embodiments, a conductive adhesion layer may be disposed between the first non-coating portion of the first substrate and the first substrate tab 112. For example, the first non-coating portion of the first substrate and the first substrate tab 112 may be bonded and electrically connected to each other through the conductive adhesion layer. In some embodiments, a conductive adhesion layer may be disposed between a second non-coating portion of a second substrate and the second substrate tab 114. For example, the second non-coating portion of the second substrate and the second substrate tab 114 may be bonded and electrically connected to each other through the conductive adhesion layer. An example of connecting the non-coating portion of the substrate to the substrate tabs 112 and 114 is described herein with reference to FIGS. 2 to 10.

The first electrode may function as a positive electrode. In some embodiments, the first substrate may be provided as, for example, aluminum foil, and the first active material may include, for example, transition metal oxide. The second electrode may function as a negative electrode. For example, the second substrate may be provided as, for example, copper foil or nickel foil, and the second active material may include, for example, graphite.

The separator may function to prevent short circuit between the first electrode and the second electrode while allowing movement of lithium ions. The separator may be provided as, but is not limited to, a polyethylene film, a polypropylene film, a polyethylene-polypropylene film, etc. The separator of the electrode assembly 110 may be longer in a height direction of the electrode assembly 110 than the first electrode and the second electrode.

The battery 100 may include an electrode assembly 110 and an outer body that accommodates the electrode assembly 110. The outer body of the battery 100 includes a case 120 and a cap assembly 130 and may define an outer appearance of the battery 100.

The case 120 may accommodate the electrode assembly 110 and an electrolyte. The case 120 may include a sidewall having an approximately cylindrical shape and a bottom part connected to one side of the sidewall. However, it is not limited thereto, and the case 120 may be configured in various shapes such as circular or pouch type. In some embodiments, the case may be made of a metal such as aluminum, an aluminum alloy, or nickel-plated steel, or a laminated film or plastic that forms the pouch.

The case 120 may accommodate the electrode assembly 110. The electrode assembly 110 may be inserted through an opening defined at one side of the case 120. Thereafter, the opening of the case 120 may be sealed by the cap assembly 130. Referring to FIG. 1, welding may be performed on welding areas A and A′ to seal the opening of the case 120 by the cap assembly 130.

The cap assembly 130 may include a cap plate 132, an insulating layer 134, a terminal plate 136, and an insulating member 138. In some embodiments, the cap plate may cover the opening of the case 120. The cap plate 132 may be coupled to a side surface of the case 120 corresponding to a side surface of the opening.

An insertion groove may be defined in the cap plate 132. For example, the insertion groove may be defined at a center of the cap plate 132. A portion of the terminal plate 136 (e.g., an insertion part 136b of the terminal plate) may be inserted into the insertion groove, and the terminal plate 136 may be disposed on the cap plate 132. The terminal plate 136 may include a body part 136a and an insertion part 136b protruding from the body part 136a. In some embodiments, the insertion part 136b of the terminal plate 136 may be inserted into the insertion groove of the cap plate 132. In some embodiments, the insertion part 136b of the terminal plate 136 may be electrically connected by being in contact with the first substrate tab 112. Referring to FIG. 1, the cap assembly 130 including the terminal plate 136 may be coupled to the case 120 so that the insertion part 136b faces the electrode assembly. However, in some embodiments, the cap assembly may be coupled to the case so that the insertion part of the terminal plate faces a direction opposite to the electrode assembly (i.e., toward a top surface of the battery), but is not limited thereto.

The insulating layer 134 may be disposed between the terminal plate 136 and the cap plate 132. The insulating layer 134 may have adhesive strength to couple the terminal plate 136 to the cap plate 132. The insulating layer 134 may be made of an insulating material to electrically insulate the terminal plate 136 and the cap plate 132 from each other.

In some embodiments, the insulating member 138 may be disposed on a bottom surface of the cap plate 132. In some embodiments, a top surface of the cap plate 132 may face the body part 136a of the terminal plate 136, and the bottom surface of the cap plate 132 may face the electrode assembly. The insulating member 138 may be made of an insulating material to insulate the cap plate 132 and the electrode assembly 110 from each other or insulate the cap plate 132 and the first substrate tab 112 from each other.

In some embodiments, the electrode assembly 110 may include a finishing tape 118 that wraps at least a portion of the outermost circumference of the electrode assembly 110. Here, the finishing tape 118 may secure the wound electrode assembly 110. For example, in the electrode assembly 110, the winding of the first electrode, the second electrode, and the separator may be maintained without being released by the finishing tape 118. For example, the finishing tape may have adhesive strength that adheres the finishing tape to at least a portion of the outermost circumference of the electrode assembly 110.

In some embodiments, the first substrate tab 112 may be bent under the terminal plate 136 in the case 120 in which the electrode assembly 110 is accommodated, and the first cap assembly 130 is coupled. The bent first substrate tab 112 may be prevented from being short-circuited with the electrode assembly 110 by an insulating washer 140. The insulating washer 140 may be disposed between the electrode assembly 110 and the terminal plate 136. In some embodiments, the insulating washer 140 may be disposed between the first substrate tab 112 disposed below the terminal plate 136, and the electrode assembly 110. The insulating washer 140 may include an insulating material. The insulating washer 140 may separate the first substrate tab 112 and the electrode assembly 110 from each other. In some embodiments, the insulating washer 140 may electrically insulate the first substrate tab 112 and the electrode assembly 110 from each other.

FIG. 2 illustrates an enlarged side view of an example of electrodes 210 and 220 according to an embodiment of the present disclosure. As shown, the electrode assembly may be configured by winding a first electrode 210, a second electrode 220, and a separator 230 interposed between the first electrode 210 and the second electrode 220.

The enlarged view B may be a side view that enlarges a portion of the first electrode 210. Referring to the enlarged view B, the first electrode 210 may include a first substrate 212 and a first substrate tab 214 connected to the first substrate 212. The first substrate 212 may extend in a first direction X. In some embodiments, the first direction X may mean a longitudinal direction of the first substrate 212.

In some embodiments, a first mixture portion coated with an active material may be disposed on an area of the first substrate 212 (e.g., an area excluding an end of the first substrate) with respect to the first direction X. The first mixture portion may be provided by applying the active material to at least one surface of the first substrate 212. A first non-coating portion on which the active material is not applied to expose the first substrate 212 may be disposed on an end of the first substrate 212 with respect to the first direction X.

The first substrate tab 214 may be connected to the first non-coating portion of the first substrate 212. For example, the first substrate tab 214 may protrude in a second direction Y that intersects the first direction in which the first substrate 212 extends. In some embodiments, the second direction Y may correspond to a width direction of the first substrate, but is not limited thereto. In some embodiments, the first direction X and the second direction Y are illustrated to be perpendicular to each other, but are not limited thereto.

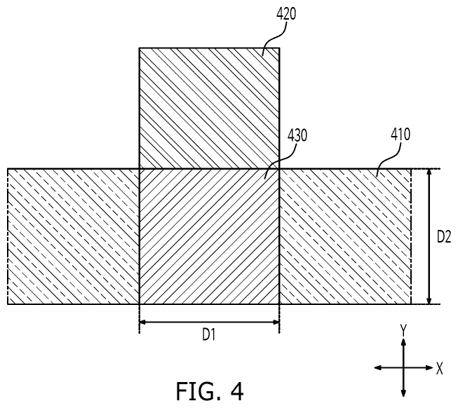

An adhesion layer 240 may be disposed between the first non-coating portion of the first substrate 212 and the first substrate tab 214. An adhesion layer 240 may be disposed entirely on an area on which the first non-coating portion and the first substrate tab 214 overlap each other. In some embodiments, the adhesion layer 240 may be disposed to at least include an area on which the first non-coating portion and the first substrate tab 214 overlap each other. An example of an area on which the adhesion layer 240 is disposed is described herein with reference to FIGS. 4 to 9.

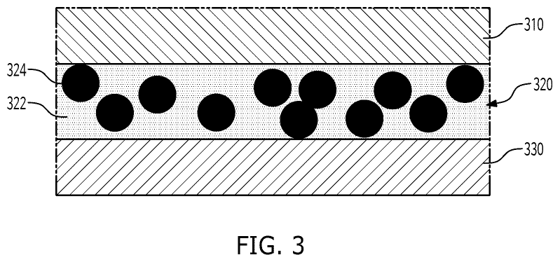

At least a portion of the adhesion layer 240 may include a conductive material. For example, the adhesion layer 240 may include at least one of isotropic conductive adhesives (ICAs) or anisotropic conductive adhesives (ACAs). A specific example of the adhesion layer 240 including a conductive material is described herein with reference to FIG. 3.

In FIG. 2, an example in which the first non-coating portion of the first substrate 212 and the first substrate tab 214 are connected through the adhesion layer 240 in the first electrode 210 has been described, but this embodiment may be similarly applied to the second electrode 220. For example, the second non-coating portion of the second substrate of the second electrode 220 and the second substrate tab 224 may also be connected through the adhesion layer.

FIG. 3 illustrates a cross-sectional view of an example of an adhesion layer 320 according to an embodiment of the present disclosure. As shown in the drawing, the adhesion layer 320 may be disposed between a non-coating portion of a substrate and a substrate tab 330. The adhesion layer 320 may include a conductive material. In some embodiments, the non-coating portion 310 of the substrate and the substrate tab 330 may be electrically connected through the adhesion layer 320.

In some embodiments, the adhesion layer 320 may include a binder layer 322 and conductive particles 324 included within the binder layer 322. The binder layer 322 may provide adhesive properties to serve to disperse the conductive particles 324. The binder layer 322 may include, but is not limited to, an epoxy resin, silicone, acrylate, etc. The conductive particles 324 may be dispersed within the binder layer 322. In some embodiments, the conductive particles 324 may include fine metal particles such as nickel or silver, but are not limited thereto. A diameter of the conductive particle 324 may be about 5 μm to about 20 μm, but is not limited thereto.

In some embodiments, if heat and/or a pressure is applied to the adhesion layer 320, the conductive particles 324 may be in electrical contact with each other to current to be applied within the adhesion layer 320. In some embodiments, the binder layer 322 may be cured by heat, and thus, the non-coating portion of the substrate and substrate tab 330 may be maintained in an adhering state.

In some embodiments, the adhesion layer 320 may include at least one of isotropic conductive adhesives (ICAs) or anisotropic conductive adhesives (ACAs).

In some embodiments, the adhesion layer 320 may be in the form of a conductive adhesive. In some embodiments, the adhesion layer 320 may be provided by applying a conductive adhesive on the non-coating portion 310 of the substrate or the substrate tab 330. In other embodiments, the adhesion layer 320 may be in the form of a conductive tape. In some embodiments, the adhesion layer 320 may be provided by attaching the conductive tape to the non-coating portion 310 of the substrate or the substrate tab 330.

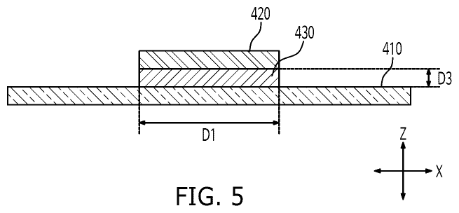

FIG. 4 illustrates a one-way side view of an example of an adhesion layer 430 of an electrode according to a first embodiment of the present disclosure, and FIG. 5 illustrates a cross-sectional view of an example of an adhesion layer 430 of an electrode according to the first embodiment of the present disclosure.

Referring to FIGS. 4 and 5, an electrode may include a substrate 410 and a substrate tab 420. The substrate 410 may extend in the first direction X and may include a mixture portion, on which an active material is applied to at least one surface of the substrate 410, and a non-coated portion on which the active material is not applied to the substrate 410. The substrate tab 420 may be connected to the non-coating portion of the substrate 410.

In some embodiments, the substrate tab 420 may be connected to protrude to one side with respect to a width direction of the substrate 410. For example, one end of the substrate tab 420 may protrude in a second direction Y that intersects the first direction in which the substrate 410 extends. In some embodiments, the other end of the substrate tab 420 may not protrude from the substrate 410 and may be disposed to be in contact with a side end of the substrate 410, but is not limited thereto.

In some embodiments, an adhesion layer 430 may be disposed between the non-coating portion of the substrate 410 and the substrate tab 420. The adhesion layer 430 may be disposed entirely on an area on which the non-coating portion and the substrate tab 420 overlap each other. In some embodiments, a width of the adhesion layer 430 may correspond to a width D1 of the substrate tab 420 with respect to the first direction X. In some embodiments, the width of the adhesion layer 430 may correspond to a width D2 of the substrate 410 with respect to the second direction Y.

As a thickness D3 of the adhesion layer 430 becomes thicker, contact between conductive particles may be hindered, and current conduction between the substrate 410 and the substrate tab 420 may be decreased due to resistance generated in the adhesion layer 430. In addition, as the thickness D3 of the adhesion layer 430 becomes thinner, adhesive performance may be deteriorated, and a limitation in which the substrate tab 420 is detached from the substrate 410 may occur. In some embodiments, the thickness D3 of the adhesion layer 430 may be about 20 μm or more and about 50 μm or less, but is not limited thereto.

Due to this configuration, the adhesion layer 430 may be disposed entirely on an area on which the substrate 410 and the substrate tab 420 overlap each other, and thus, an area on which the substrate 410 and the substrate tab 420 are connected may be maximized. In some embodiments, stress concentrated at the connection portion between the substrate 410 and the substrate tab 420 may be dispersed as much as possible due to elongation of the substrate 410 to prevent cracks from occurring in the substrate 410 or prevent the substrate tab 420 from being separated from the substrate 410.

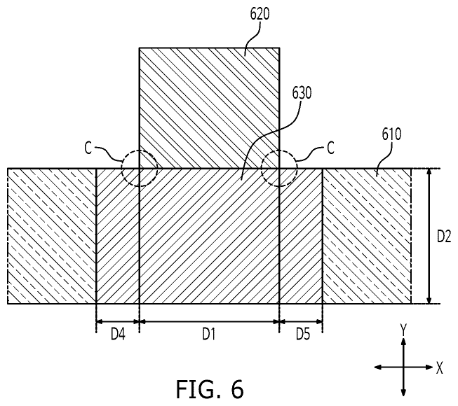

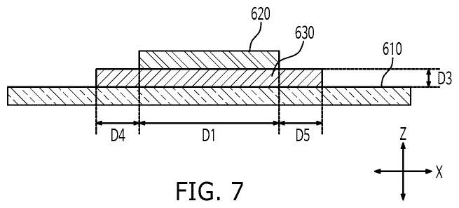

FIG. 6 illustrates a one-way side view of an example of an adhesion layer 630 of an electrode according to a second embodiment of the present disclosure, and FIG. 7 illustrates a cross-sectional view of an example of an adhesion layer 630 of an electrode according to the second embodiment of the present disclosure. In FIGS. 6 and 7, configurations described or duplicated in FIGS. 4 and 5 will be omitted.

Referring to FIGS. 6 and 7, an electrode may include a substrate 610 and a substrate tab 620. The substrate 610 may extend in the first direction X, and the substrate tab 620 may be connected to a non-coating portion of the substrate 610. The substrate tab 620 may be connected to protrude in the second direction Y that intersects the first direction in which the substrate 610 is extends. In FIG. 6, the substrate tab 620 is illustrated as extending to protrude in a direction perpendicular to the first direction X in which the substrate 610 extends, but is not limited thereto.

In some embodiments, an adhesion layer 630 may be disposed between the non-coating portion of the substrate 610 and the substrate tab 620. The adhesion layer 630 may be disposed entirely on an area on which the substrate 610 and the substrate tab 620 overlap each other. In some embodiments, the adhesion layer 630 may be disposed on an area that is wider than the area on which the substrate 610 and the substrate tab 620 overlap each other. In some embodiments, a width of the adhesion layer 630 may greater than a width D1 of the substrate tab 620 with respect to the first direction X. In some embodiments, the adhesion layer 630 may protrude by a predetermined length toward at least one side of the substrate tab 620 with respect to the first direction X. In some embodiments, the adhesion layer 630 may protrude by a first length D4 toward one side of the substrate tab 620 with respect to the first direction X. In some embodiments, the adhesion layer 630 may protrude by a second length D5 toward the other side of the substrate tab 620 with respect to the first direction X. In some embodiments, during a process of manufacturing the electrode, after the adhesion layer 630 is disposed first on the substrate 610, the substrate tab 620 may be connected to the substrate 610 in a manner in which the substrate tab 620 is disposed on the adhesion layer 630, but is not limited thereto.

In some embodiments, with respect to the first direction X, each of the first length D4 and the second length D5 of the adhesion layer 630 protruding from the substrate tab 620 may be within about ⅓ of the width of the substrate tab 620, but is not limited thereto. In some embodiments, with respect to the first direction X, each of the first length D4 and the second length D5 of the adhesion layer 630 protruding from the substrate tab 620 may be within about 1 mm, but is not limited thereto.

Due to this configuration, stress concentrated at a corner C at which the substrate 610 and the substrate tab 620 intersect each other may be dispersed to the adhesion layer 630. In some embodiment, the stress concentrated to the corner C, at which the substrate 610 and the substrate tab 620 intersect each other, may be dispersed through elongation of a binder layer of the adhesion layer 630 to prevent cracks from occurring in the substrate 610 or prevent the substrate tab 620 from being separated from the substrate 610.

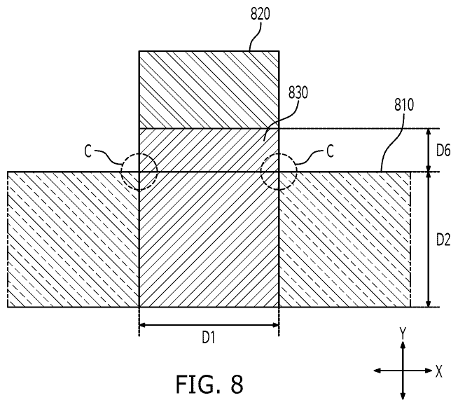

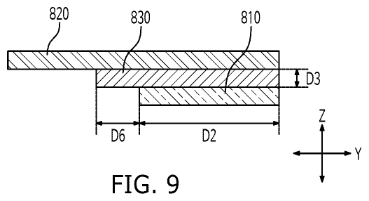

FIG. 8 illustrates a one-way side view of an example of an adhesion layer 830 of an electrode according to a third embodiment of the present disclosure, and FIG. 9 illustrates a cross-sectional view of an example of an adhesion layer 830 of an electrode according to the third embodiment of the present disclosure. In FIGS. 8 and 9, configurations described or duplicated in FIGS. 4 to 7 will be omitted.

Referring to FIGS. 8 and 9, an electrode may include a substrate 810 and a substrate tab 820. The substrate 810 may extend in the first direction X, and the substrate tab 820 may be connected to a non-coating portion of the substrate 810. The substrate tab 820 may be connected to protrude in the second direction Y that intersects the first direction in which the substrate 810 is extends. In FIG. 8, the substrate tab 820 is illustrated as extending to protrude in a direction perpendicular to the first direction X in which the substrate 810 extends, but is not limited thereto.

In some embodiments, an adhesion layer 830 may be disposed between the non-coating portion of the substrate 810 and the substrate tab 820. The adhesion layer 830 may be disposed entirely on an area on which the substrate 810 and the substrate tab 820 overlap each other. In some embodiments, the adhesion layer 830 may be disposed on an area that is wider than the area on which the substrate 810 and the substrate tab 820 overlap each other. In some embodiments, a width of the adhesion layer 830 may be greater than a width D2 of the substrate 810 with respect to the second direction Y. In some embodiments, the adhesion layer 830 may protrude by a third length D6 from the substrate 810 in a direction in which the substrate tab 820 protrudes. In some embodiments, during a process of manufacturing the electrode, after the adhesion layer 830 is disposed first on the substrate tab 820, the substrate 810 may be connected to the substrate tab 820 in a manner in which the substrate 810 is disposed on the adhesion layer 830, but is not limited thereto.

In some embodiments, the third length D6 by which the adhesion layer 830 protrudes from the substrate 810 in the second direction Y may be within about ⅓ of a width of the substrate 810, but is not limited thereto. In some embodiments, the third length D6 of the adhesion layer 830 protruding from the substrate 810 may be within about 1 mm with respect to the second direction Y, but is not limited thereto.

Due to this configuration, stress concentrated to a corner C, at which the substrate 810 and the substrate tab 820 intersect each other, may be dispersed to the adhesion layer 830 to prevent cracks from occurring in the substrate 810 or prevent the substrate tab 820 from being separated from the substrate 810.

In FIGS. 6 and 7, an example in which the adhesion layer protrudes beyond the substrate tab in the first direction X are shown, and in FIGS. 8 and 9, an example in which the adhesion layer protrudes beyond the substrate in the second direction Y are shown, but embodiments of the technology described herein is not limited thereto, and, in some embodiments, the adhesion layer may protrude beyond the substrate tab in the first direction X and also protrude beyond the substrate in the second direction Y.

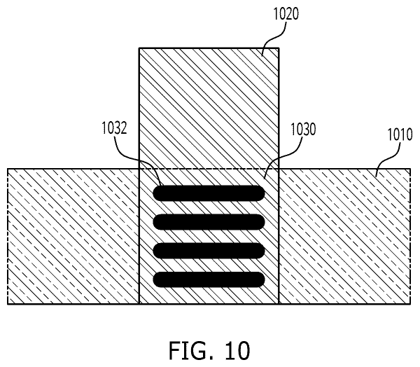

FIG. 10 illustrates a view of an example of a coating method using an adhesive according to an embodiment of the present disclosure. Referring to FIG. 10, an electrode may include a substrate 1010 and a substrate tab 1020 connected to a non-coating portion of the substrate 1010. An adhesion layer may be disposed on an area 1030 on which the substrate 1010 and the substrate tab 1020 overlap each other. The adhesion layer may be provided by applying a conductive adhesive to one area of the substrate 1010 or the substrate tab 1020 or by attaching a conductive tape. FIG. 10 illustrates an example in which a conductive adhesive 1032 is applied to an area of a substrate 1010 or a substrate tab 1020.

In some embodiments, the conductive adhesive 1032 may be applied by a line coating method within the area 1030 on which the substrate 1010 and the substrate tab 1020 overlap each other. For example, the conductive adhesive 1032 may be continuously discharged through an adhesive dispenser or the like. Thereafter, the substrate 1010 and the substrate tab 1020 may be pressed, and thus, the conductive adhesive 1032 may be evenly spread throughout the area 1030 on which the substrate 1010 and the substrate tab 1020 overlap each other. If using the line coating method, an amount of conductive adhesive 1032 to be discharged may be controlled constantly, and thus, the conductive adhesive 1032 may be applied uniformly. For example, compared to if using a dot coating method, an adhesion layer having a thinner and more uniform thickness may be formed with the same amount of conductive adhesive 1032.

In FIG. 10, the conductive adhesive 1032 is shown as being applied to a plurality of separation lines within the area 1030 on which the substrate 1010 and the substrate tab 1020 overlap each other, but this is only an example of the adhesive coating method and is not limited thereto. For example, the conductive adhesive 1032 may be applied in a single line. In some embodiments, the conductive adhesive 1032 may be applied over a wider area than the area 1030 on which the substrate 1010 and the substrate tab 1020 overlap each other.

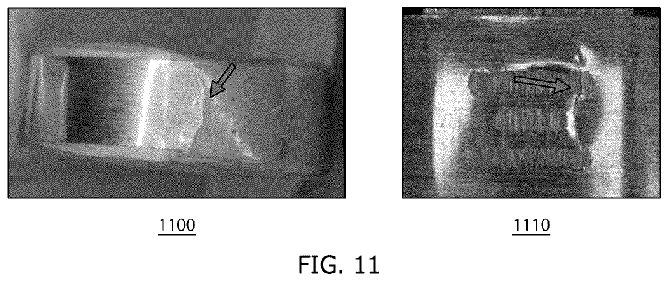

FIG. 11 illustrates a view of a comparative example of an electrode. A first comparative example 1100 and a second comparative example 1110 illustrate an example in which a substrate and a substrate tab are connected by welding coupling.

Referring to the first comparative example 1100 and the second comparative example 1110, it may be confirmed that cracks occur at a portion at which the substrate and the substrate tab are welded together. If welding the substrate and substrate tab, the entire overlapping area of the substrate and substrate tab may not be bonded to each other, and thus, stress may be concentrated to a local portion at which the welding coupling is performed. In some embodiments, the cracks may occur at the welded and coupled portion between the substrate and substrate tab, or the substrate tab may be separated from the substrate.

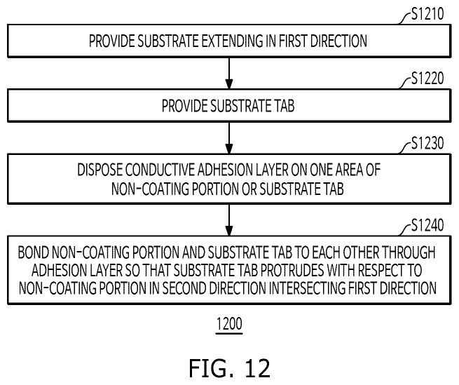

FIG. 12 illustrates a flowchart for explaining a method 1200 for manufacturing a battery according to an embodiment of the present disclosure. The method 1200 for manufacturing the electrode may be disclosed by providing a substrate extending in the first direction (S1210). Here, the substrate may include a mixture portion, on which an active material is applied to at least one surface of the substrate, and a non-coating potion disposed on an end of the substrate to expose the substrate. Thereafter, a substrate tab connected to the substrate may be provided (S1220).

Then, a conductive adhesion layer may be disposed on one area of the non-coating portion or substrate tab (S1230). In some embodiments, the adhesion layer may include at least one of isotropic conductive adhesives (ICAs) or anisotropic conductive adhesives (ACAs).

In some embodiments, a width of the adhesion layer in the first direction may correspond to a width of the substrate tab. In other embodiments, the width of the adhesion layer may be greater than the width of the substrate tab with respect to the first direction, and the adhesion layer may protrude toward at least one side of the substrate tab by a first length with respect to the first direction. In some embodiments, the first length of the adhesion layer protruding from the substrate tab may be within about ⅓ of the width of the substrate tab. In some embodiments, the first length of the adhesion layer protruding from the substrate tab may be within about 1 mm.

In some embodiments, a width of the adhesion layer in the first direction may correspond to a width of the substrate. The adhesion layer may protrude by a second length from the substrate in the direction in which the substrate tab protrudes.

Then, the non-coating portion and the substrate tab may be bonded through the adhesion layer so that the substrate tab protrudes with respect to the non-coating portion in a second direction intersecting the first direction (S1240). After the non-coating portion and the substrate tab are bonded to each other, the substrate tab may be pressed. For example, if the adhesion layer is a conductive adhesive applied in a line coating manner, the substrate tab may be pressed, and thus, the conductive adhesive may be evenly spread throughout the area where the substrate (non-coating portion) and the substrate tab overlap each other.

The flowchart of FIG. 12 and the description above are only examples of the present disclosure, and the scope of the present disclosure is not limited to the flowchart of FIG. 12 and the description above. For example, one or more processes in the flowchart and the descriptions described above may be added/changed/deleted, the order of one or more processes may be changed, and one or more processes may be performed simultaneously.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

100: Battery

110: Electrode assembly

112: First substrate tab

114: Second substrate tab

118: Finishing tape

120: Case

130: Cap assembly

132: Cap plate

134: Insulating layer

136: Terminal plate

136a: Body part

136b: Insertion part

138: Insulating member

140: Insulating washer

What is claimed is:

1. An electrode comprising:
a substrate extending in a first direction, wherein the substrate comprises:
a mixture portion, on which an active material is applied to at least one surface of the substrate; and
a non-coating portion disposed on an end of the substrate and at which the substrate is exposed;
a substrate tab connected to the non-coating portion and protruding in a second direction that intersects the first direction; and
a conductive adhesion layer disposed between the non-coating portion and the substrate tab.

2. The electrode as claimed in claim 1, wherein a width of the adhesion layer is equal to a width of the substrate tab with respect to the first direction.

3. The electrode as claimed in claim 1, wherein a width of the adhesion layer is greater than a width of the substrate tab with respect to the first direction, and the adhesion layer protrudes by a first length to at least one side of the substrate tab with respect to the first direction.

4. The electrode as claimed in claim 3, wherein the first length by which the adhesion layer protrudes from the substrate tab is within about ⅓ of the width of the substrate tab.

5. The electrode as claimed in claim 3, wherein the first length by which the adhesion layer protrudes from the substrate tab is within about 1 mm.

6. The electrode as claimed in claim 1, wherein a width of the adhesion layer is equal to a width of the substrate with respect to the second direction.

7. The electrode as claimed in claim 1, wherein a width of the adhesion layer is greater than a width of the substrate with respect to the second direction, and
the adhesion layer protrudes further than the substrate by a second length in a direction in which the substrate tab protrudes.

8. The electrode as claimed in claim 1, wherein, in the adhesion layer, a conductive adhesive is applied to the non-coating portion of the substrate or the substrate tab.

9. The electrode as claimed in claim 1, wherein, in the adhesion layer, a conductive tape is attached to the non-coating portion of the substrate or the substrate tab.

10. The electrode as claimed in claim 1, wherein the adhesion layer comprises at least one of isotropic conductive adhesives (ICAs) or anisotropic conductive adhesives (ACAs).

11. The electrode as claimed in claim 1, wherein the adhesion layer has a thickness of about 20 μm to about 50 μm.

12. A method of manufacturing an electrode, the method comprising:
providing a substrate extending in a first direction, the substrate comprising:
a mixture portion, on which an active material is applied to at least one surface of the substrate; and
a non-coating portion disposed on an end of the substrate and at which the substrate is exposed;
providing a substrate tab;
disposing a conductive adhesion layer on one area of the non-coating portion or the substrate tab; and
bonding the non-coating portion and the substrate tab to each other through the adhesion layer so that the substrate tab protrudes with respect to the non-coating portion in a second direction that intersects the first direction.

13. The method as claimed in claim 12, wherein a width of the adhesion layer is equal to a width of the substrate tab with respect to the first direction.

14. The method as claimed in claim 12, wherein a width of the adhesion layer is greater than a width of the substrate tab with respect to the first direction, and
the adhesion layer protrudes by a first length to at least one side of the substrate tab with respect to the first direction.

15. The method as claimed in claim 14, wherein the first length by which the adhesion layer protrudes from the substrate tab is within about ⅓ of the width of the substrate tab.

16. The method as claimed in claim 14, wherein the first length by which the adhesion layer protrudes from the substrate tab is within about 1 mm.

17. The method as claimed in claim 12, wherein a width of the adhesion layer is equal to a width of the substrate with respect to the second direction.

18. The method as claimed in claim 12, wherein the adhesion layer protrudes further than the substrate by a second length in a direction in which the substrate tab protrudes.

19. The method as claimed in claim 12, wherein the adhesion layer includes at least one of isotropic conductive adhesives (ICAs) or anisotropic conductive adhesives (ACAs).

20. The method as claimed in claim 12, further comprising, after bonding the non-coating portion and the substrate tab to each other, pressing the substrate tab.
